(19) United States
(12) Patent Application Publication
(10) Pub. No.: US 2015/0321498 A1
(43) Pub. Date: Nov. 12, 2015

(54) TRANSPARENT NOTE SHEET AND METHOD FOR MANUFACTURING THE SAME

(71) Applicant: 3M INNOVATIVE PROPERTIES COMPANY, Saint Paul, MN (US)

(72) Inventors: Atsushi TOYOTA, Kanagawa (JP); Robert A. YAPEL, Oakdale, MN (US); Mitchell A.F. JOHNSON, Maplewood, MN (US); David M. MAHLI, Woodbury, MN (US); Frederick J. GUSTAFSON, Bloomington, MN (US); Lan H. LIU, Rosemount, MN (US); Yu YANG, Eden Prairie, MN (US)

(21) Appl. No.: 14/648,211

(22) PCT Filed: Nov. 27, 2013
(86) PCT No.: PCT/US2013/072156

§ 371 Date: May 28, 2015

Related U.S. Application Data
(60) Provisional application No. 61/731,964, filed on Nov. 30, 2012.

(51) Int. Cl. B42D 5/00; B05D 7/00; B05D 3/00

(52) U.S. Cl. CPC B42D 5/003; B05D 3/007; B05D 7/50

(57) ABSTRACT

A note sheet comprising: (1) a substrate having a first main face and a second main face; (2) a writing receptive layer on the first main face of the substrate, the writing receptive layer having an exposed face or writing surface having a fine relief structure; and (3) at least one segment of repositionable pressure-sensitive adhesive layer on at least a portion of the second main face; wherein the substrate and writing receptive layer having a visible transmittance of at least about 80% and a haze of not more than about 60%. Also a method for making such sheets.

### FIELD OF THE INVENTION

The present invention relates to a transparent note sheet having a writable front surface and a back surface provided with a pressure-sensitive adhesive layer; and a method for manufacturing the same.

### BACKGROUND OF THE INVENTION

Note sheets having a writable front surface and a back surface provided with a pressure-sensitive adhesive layer are widely used as communication tools in business or learning environments, as marking tools for indicating a specific part of a document, and so forth.

Examples of such products include sheet products such as memos, notes, flags, and the like known under the POST-IT® Brand by 3M Company, and the like. With these products, information can be written on the front surface of the sheet and can be affixed to a desired adherend. Alternatively, these notes sheets can be used as flags to mark a specific part of an adherend such as a document, page in a book, or the like; and can be peeled/removed without damaging the adherend in order to change the affixed position thereof or when it is no longer desired.

WO88/09983 (Miles et al.) discloses a substantially transparent note sheet that uses a flexible polymeric material as a substrate. The back surface of a first end of the substrate is coated with a pressure-sensitive adhesive, and the front surface of a second end can be written on. When affixed to a base (adherend), characters written on the adherend can be read through the sheet.

With sheet products having a pressure-sensitive adhesive that use a flexible polymeric material (i.e. a resin film) as a substrate, in order to enable writing on the front surface of the sheet (hereinafter referred to as “writability”), a fine relief structure is commonly formed on the front surface of the sheet. With sheets having a pressure-sensitive adhesive such as flags using conventional resin films, a method in which a coating including beads or particles is applied to the front surface of the sheet is typically used in order to form this fine relief structure. In this method, convexities and concavities having sizes and shapes of the beads or particles are formed on the front surface of the sheet. For example, Japanese Unexamined Patent Application Publication No. 2011-131513 describes an affixable flag coated with a writing layer including calcium carbonate having an average particle size of 0.3 μm to 10 μm and silica particles having an average particle size of 1 μm to 10 μm.

The needs frequently arises for note sheets to be transparent so as to enable reading of the information of the adherend when affixing the sheets to an adherend using a pressure-sensitive adhesive layer.

In order to obtain desirable writability, a fine relief structure is commonly formed on the front surface of the sheet. Light scattering easily occurs in the front surfaces of sheets that have convexities and concavities. Additionally, as described above, the fine relief structure on the front surface of the sheet is formed by coating a resin including beads or particles to the front surface of the sheet. Therefore, in addition to the light scattering caused by the convexities and concavities, because there is a difference between the refractive indices of the coating layer and the particles or beads included therein, light scattering at interfaces thereof occurs easily. As a result, due to this light scattering factor, the front surface of the sheet will appear to be white, a matte appearance will be expressed, a haze value will be high, and desired high transparency is not obtained.

As described above, in conventional sheet products, methods in which a resin coating material including particles or beads is applied to the front surface of the sheet are known as methods for forming the fine relief structure on the front surface of the resin sheet. However, in these cases, the particles or beads must be uniformly dispersed in the resin coating material. Controlling the coating of such a uniform dispersion is not easy.

Known methods for providing convexities and concavities to a surface of a resin substrate in fields other than that of sheet products such as flags and the like include: (1) emboss finishing, (2) sand blast finishing, and (3) hairline finishing.

With emboss finishing, for example, a roller having a surface provided with a relief structure is heat-pressed on a thermoplastic resin surface in order to transfer the surface shape of the roller and form fine convexities and concavities on the resin surface. However, with this method, the type of resin sheet that can be used is limited to thermoplastic resin sheets, and tools such as rollers provided with specialized patterns, and the like, must be prepared. Moreover, reproducing fine convexities and concavities is difficult.

Sand blast finishing is a process in which a surface is abraded by spraying a resin substrate surface with an abrasive material and compressed-air. Additionally, hairline finishing is a process in which narrow, hair-like scratches are provided in a resin substrate surface using a lathe or the like. However, with these finishing processes, processing apparatuses are needed and, moreover, it is not easy to adjust the fine convexities and concavities.

The need exists for highly transparent, low haze note sheets that exhibit superior writability.

### SUMMARY OF THE INVENTION

The present invention provides highly transparent, low haze note sheets that exhibit superior writability. The invention also provides a method for making such sheets.

In brief summary, a note sheet of the invention comprises: (1) a substrate having a first main face and a second main face; (2) a writing receptive layer on the first main face of the substrate, the writing receptive layer having an exposed face having a fine relief structure; and (3) at least one segment of repositionable pressure-sensitive adhesive layer on at least a portion of the second main face; wherein the substrate and writing receptive layer having a visible transmittance of at least about 80% and a haze of not more than about 60%.

Briefly summarizing, the method of the invention comprises:

(1) providing a substrate having a first main face and a second main face;

(2) applying a transparent resin coating material to the first main face so as to form a coat layer precursor having a first main face;

(3) contacting the surface of the coat layer precursor with a roller surface and then separating the roller surface from the coat layer precursor;

(4) curing the coat layer precursor to form a resin coat layer; and

(5) applying at least one segment of repositionable pressure-sensitive adhesive on at least a portion of the second main face of the substrate;

thereby yielding a transparent note sheet.

### BRIEF DESCRIPTION OF THE DRAWINGS

The invention is further explained with reference to the drawing wherein:

FIG. 1 is a perspective view of an illustrative embodiment of note sheet of the present invention;

FIG. 2 is a cross-sectional view of the note sheet of FIG. 1;

FIG. 3 is an enlarged cross-sectional schematic of a portion of the note sheet of FIG. 1;

FIG. 4 is a cross-sectional view of another illustrative embodiment of note sheet of the present invention;

FIG. 5 is a schematic view of an illustrative example of a manufacturing system used to manufacture the note sheets of the present invention;

FIG. 6 is a schematic illustration of formation of fine relief features for a writing surface of the invention;

FIG. 7 is a cross-sectional view of another illustrative embodiment of note sheet of the present invention;

FIG. 8 is an enlarged cross-sectional schematic of a portion of a note sheet of another illustrative embodiment of the present invention;

FIG. 9 is a schematic drawing illustrating writing on a note sheet of the present invention using an aqueous gel ink pen;

FIG. 9A is an enlarged cross-sectional view of the contact state between a pen tip and the writing receptive layer of a note sheet of the invention;

FIG. 10 is a drawing illustrating a definition of a distance between adjacent peaks NNp in the relief structure of the front surface of the notes sheets of the Examples;

FIG. 11 is an electron microgram depicting the fine relief state of the front surface of one embodiment of note sheet of the present invention;

FIG. 12 is a graph showing a relationship between a ratio (Rₐ/NNp) of an arithmetic surface roughness Rₐ of the fine relief structure to the distance between adjacent peaks NNp and a haze value; and

FIG. 13 is a graph showing a relationship between a ratio (Rₐ/NNp) of an arithmetic surface roughness Rₐ of the fine relief structure to the distance between adjacent peaks NNp and a writability evaluation score.

These figures are not to scale and are intended to be merely illustrative and not limiting.

### DETAILED DESCRIPTION OF ILLUSTRATIVE EMBODIMENTS OF THE INVENTION

A note sheet of the present invention note sheet comprises: (1) a substrate having a first main face and a second main face; (2) a writing receptive layer on the first main face of the substrate, the writing receptive layer having an exposed face having a fine relief structure; and (3) at least one segment of repositionable pressure-sensitive adhesive layer on at least a portion of the second main face. In accordance with the present invention, in addition to providing a writing receptive layer, the wherein the substrate and writing receptive layer having a visible transmittance of at least about 80% and a haze of not more than about 60%. Note sheets of the invention are well suited for use as a memo, note, label, flag, or the like, particularly for use where it is desired to be able to read or view the underlying adherend to which they are adhered.

The fine relief structure formed on the surface of the resin coat layer of the note sheet of the embodiments is constituted by the resin coat layer itself and is a smooth fine relief structure. The relief structure is not formed by a resin coat layer including a mixture of beads or particles, in which the relief structure reflects the shape of the beads of particles, as with conventional technology. While this fine relief structure provides a surface that can be written on using a writing instrument such as a pencil or the like, because the relief structure is constituted by only the resin coat layer, light scattering at interfaces based on the difference between the refractive indices of the beads or particles and the resin does not occur. As a result, compared to a conventional note sheet product a note sheet having a more clear appearance with a lower haze value can be provided.

With these note sheets, desired characters and graphics can be drawn on the front surface of the note sheet using a writing instrument such as a pencil, a mechanical pencil, an oil felt marker, an oil ballpoint pen, a marker, or the like. Moreover, the note sheets can be repositionably affixed on a document or drawing and the document or drawing can be more clearly seen through the note sheet before and after affixing. A use in which the note sheets are affixed to a map or drawing and then the underlying image is traced is an illustrative use made possible by the invention.

Substrate

Those skilled in the art will be able to readily select suitable substrate materials. The substrate 101 should exhibit suitable flexibility and tear strength for fabrication of, and use as, a transparent note of the invention.

Many known polymeric films and the like can be used in accordance with the invention. The substrate should be transparent, in at least the cross direction, having a transmittance in the visible range of at least about 80%, and preferably at least about 90%. The substrate may be colored if desire.

Illustrative useful resin materials include polyester, triacetate (TAC), polyethylene naphthalate, polycarbonate, cellulose acetate, and poly(methyl methacrylate) films; polyolefin films such as biaxially oriented polypropylene (BOPP), simultaneously biaxially oriented polypropylene (S-BOPP); and the like. Furthermore, the resin substrate 101 may include a polyamide, a polyimide, a phenolic resin, a polystyrene, a styrene-acrylonitrile copolymer, an epoxy, and the like, or a blend thereof.

Thickness of the substrate 101 is not particularly limited, and will typically be less than about 0.5 mm, and more typically from about 0.02 to about 0.2 mm.

The substrate 101 may be monolayer or multilayer, e.g., to optimize select properties. Sheets or films of the substrate can be readily formed using conventional film making techniques (e.g., casting, extrusion, etc. The film may optionally be orientation, e.g., uniaxially, biaxially, etc., to impart desired properties to the resultant substrate.

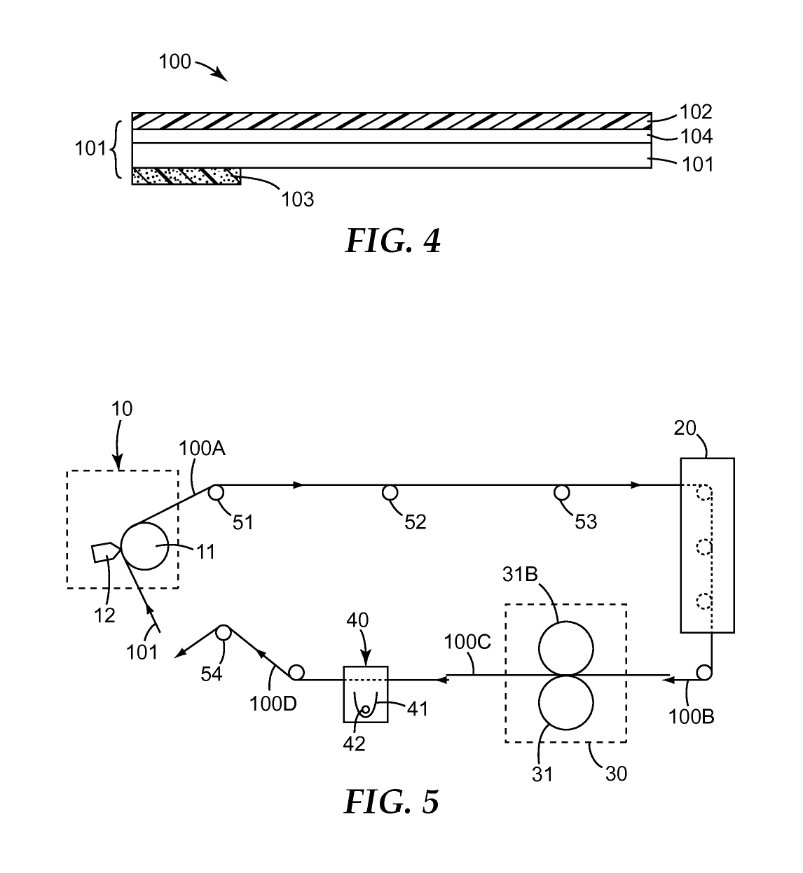

In some embodiments, the first main face (i.e., will be the front face) of the substrate 101 may be treated in order to improve the state of adhesion with the resin coat layer 102 thereto. Illustrative examples of this treatment include chemical treatments, corona treatments (e.g. air or nitrogen corona), plasma treatment, flame treatment, and the like. In addition, as illustrated in FIG. 4, a primer layer 104 may be formed on the front surface of the substrate 101.

In some embodiments, the second main face (i.e., which will be directed toward the adherend during use of the resultant note) may be treated in order to improve adhesion of the adhesive material thereto.

Writing Receptive Layer

An important feature of notes of the invention is a writing receptive layer on the first main face of the substrate, the writing receptive layer having an exposed face having a fine relief structure.

Suitable writing receptive layers can be formed on the first main face of the substrate by:

(1) applying a transparent resin coating material to the first main face so as to form a coat layer precursor having a first main face;

(2) contacting the first main face or surface of the coat layer precursor with a roller surface and then separating the roller surface from the coat layer precursor to impart convexities and concavities, i.e., fine relief features, in the surface of the coat layer precursor; and

(3) curing the coat layer precursor to form a resin coat layer.

An illustrative system and method for making matte finish films that can be used to make writing receptive layers of the invention is disclosed in US Patent Appln. Publn. No. 2009/0029054 (Yapel et al.) which is incorporated herein by reference in its entirety.

In this process, when the roller surface and the coat layer precursor are separated after being brought into contact, the viscosity of a portion of the coat layer precursor adhered to the roller surface causes the fine relief structure to be formed on the resultant surface of the coat layer precursor. Curing the coat layer precursor then “fixes” the desired fine relief structure therein.

An advantage of forming the fine relief features via this method is that it is not necessary to entrain particles or beads in the coating to impart the desired fine relief features that impart desired writability properties to the note. In conventional products, the variation in index of refraction and other discontinuities between such particles surrounding matrix result in light scattering that impairs desired transparency.

Additionally, in this process, the fine relief structure can be formed by using variations of the form of the surface of the coat layer precursor that occur along with the bringing the roller surface and the uncured coat layer precursor into contact and the subsequent separation of the same. Therefore, a note sheet having a front surface with a fine relief structure can be formed using an extremely simple process.

In this specification, the following terms are defined as follows.

The term “sheet” includes “films” and while the thickness thereof is not limited, includes thin sheet-like or film-like laminate products having an overall thickness of less than 1 mm.

The term “fine relief structure” refers to products in which an average pitch of the convexities and concavities is at least sufficiently less than the diameter of the tip of a writing instrument, and typically refers to products in which an average distance between adjacent peaks NNp of the convexities and concavities is about 100 μm or less.

The term “transparent”, particularly when no explanation is given, will be understood to refer to transparency in the visible range.

The term “polymer” will be understood to include polymers, copolymers (e.g., polymers formed using two or more different monomers), oligomers and combinations thereof. Both block and random copolymers are included, unless indicated otherwise.

The term “repositionable pressure-sensitive adhesive layer” refers to a pressure-sensitive adhesive layer having adhesive strength by which the note sheet can be easily peeled/removed by a user after affixing the note sheet to a given adherend, and by which the note sheet can be re-affixed to a desired adherend.

The term “coating material” refers to a fluid, non-solid material (e.g. a liquid or gel material) that can be coated on a substrate surface.

The term “coat layer precursor” refers to a layer formed from the coating material applied on the substrate, that is, a layer of the non-solid coating material, prior to the completion of the final curing.

The term “face-side roller” refers to a roller or other tool that includes a surface directly contacting a first surface of the coat layer precursor obtained by coating the coating material on the first main face of the substrate. This surface of the face-side roller can be used as the “roller surface” that contacts the coat layer precursor in order to perform the fine processing of the surface of the coat layer precursor. The face-side roller does not need to be a cylindrical roller and a tool that provides one or more contact surfaces substantially the same as the face-side roller may be used. When using an actual cylindrical roller, the face-side roller may comprise any of a variety of configurations including but not limited to a belt mounted on and driven by one or more drive rollers.

The note sheet of an embodiment of the present invention will now be described in detail with reference to the drawings.

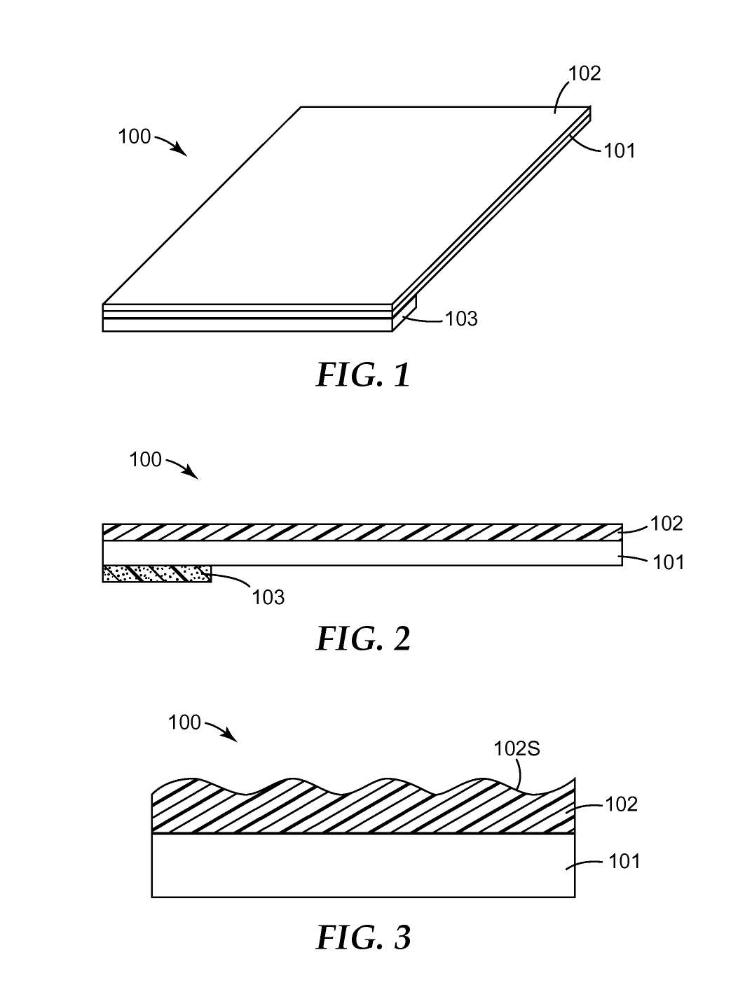

FIG. 1 is a perspective view illustrating the appearance of a note sheet according to this embodiment and FIG. 2 is a schematic cross-sectional view illustrating the same. As illustrated in FIGS. 1 and 2, a note sheet 100 according to this embodiment includes a substrate 101, and a writing receptive layer 102 formed on a front surface (first main face) of the substrate 101. Additionally, in the note sheet 100, a pressure-sensitive adhesive layer 103 is provided on at least a portion of a back surface (second main face) of the substrate 101.

A planar shape of the note sheet 100 of this embodiment is not limited to the rectangular shape depicted in FIG. 1 and, depending on the use thereof, may be circular, belt-shape, polygonal (other than rectangular), a variety of indefinite shapes, or formed into a shape of a particular design.

FIG. 3 illustrates a schematic enlarged cross-sectional view of a portion of the note sheet 100 where the pressure-sensitive adhesive layer 103 is not formed. As illustrated in FIG. 3, the writing receptive layer 102 has a smooth, fine relief structure 102S on a surface (exposed face) thereof. Due to this fine relief structure 102S, it is possible to write on the surface of the writing receptive layer 102 using a writing instrument such as a pencil, a mechanical pencil, an oil ballpoint pen, an oil felt marker, or the like. Transmittance in the visible range of the note sheet 100 in a region where the pressure-sensitive adhesive layer 103 is not present exist is at least about 80% and preferably at least about 90%. Haze is not more than about 60%, preferably not more than about 50%, and even more preferably not more than about 40%.

Surface shape of the fine relief structure 102S can be represented by various parameters (Rₐ, R_{z}, NNp, NNv or Sₘ, or the like) which are known by persons skilled in the art. These parameters indicate surface roughness or peak height or depth of valley, or the like. They are measureable using commercially available profile measurement instruments. For example, surface shape of the fine relief structure 102S can be identified by an average distance between adjacent concavities, that is, a distance between adjacent peaks (NNp) and an arithmetic average surface roughness (Rₐ).

The distance between adjacent peaks (NNp) is not more than about 100 μm. More preferably, the distance between adjacent peaks (NNp) can be configured so as to be sufficiently less than the diameter of the pen tip of commonly used writing instruments, that is, not more than about 80 μm or not more than about 50 μm.

The writability of the surface of the writing receptive layer 102 will vary depending on the type of writing instrument used. However, when an arithmetic average surface roughness (Rₐ) is not less than about 0.1 μm or not less than about 0.2 μm, and a ratio (Rₐ/NNp) of the arithmetic average surface roughness (Rₐ) to the distance between adjacent peaks (NNp) is not less than about 0.01 and preferably is not less than about 0.015, in cases where a representative writing instrument (HB pencil) is used, excellent writability that is about the same as that when writing on regular paper can be obtained.

The optical properties of this note sheet are dependent on the optical properties of each of the substrate 101 and the writing receptive layer 102 constituting the note sheet 100. The optical properties of the writing receptive layer 102 are principally dependent on the fine relief structure of the writing receptive layer 102. When the ratio (Rₐ/NNp) of the arithmetic average surface roughness (Ra) to the distance between adjacent peaks (NNp) is not more than about 0.04 and preferably not more than about 0.035, excellent transparency can be obtained in which the haze value is not more than about 60%, preferably not more than about 50%, or more preferably not more than about 40%, while maintaining the transmittance at at least about 80% or preferably about 90%.

That is, in cases where the ratio (Ra/NNp) of the arithmetic average surface roughness (Ra) of the fine relief structure of the resin coat layer 102 to the distance between adjacent peaks (NNp) is not less than about 0.01 and not more than about 0.04, a note sheet having both excellent writability and transparency can be provided. The ratio (Rₐ/NNp) may be configured to be not less than 0.015 and not more than about 0.03 or not less than about 0.02 and not more than about 0.025 in order to obtain more excellent writability and transparency.

In the embodiment described above, the fine relief structure 102S is represented by two parameters of NNp and Rₐ, however, representation by other parameters is not eliminated. For example, in cases where a maximum height of profile R_{z} (JIS B0601-2001 standard) is used instead of the arithmetic average surface roughness (Rₐ), the maximum height of profile R_{z} is not less than 1 μm or 2 μm, and the ratio (R_{z}/NNp) of the maximum height of profile (R_{z}) of the fine relief structure of the resin coat layer 102 to the distance between adjacent peaks (NNp) may be not less than about 0.1, and preferably not less than about 0.15, a note sheet having excellent writability can be provided. In cases where the ratio (R_{z}/NNp) may be configured to be not more than about 0.4, preferably, not more than about 0.35, a note sheet having excellent transparency can be provided. The distance between adjacent peaks (NNp) can be closely resembled with the mean width of roughness profile elements, Rsm (JIS B0601-2001 standard).

The material used for the writing receptive layer 102 is not limited, but is preferably a transparent resin material to which a fine processing process (described hereinafter) can be applied. From this perspective, a transparent resin material is preferably used that has flowability under certain conditions, that can be coated on the front surface of the substrate, and that can be cured after the fine processing in a state where the fine relief structure on the surface is substantially maintained.

Additionally, because a variety of writing instruments are used to write on the surface of the resin coat layer, the surface of the cured resin coat layer may have a hardness such that the writing instrument such as a pencil or the like will not scratch the surface (e.g., a hardness greater or equal to pencil hardness H).

For example, liquid resins such as ionizing radiation (UV rays or electron beams) curable resins, aqueous solutions of water soluble resins, and solutions in which a resin is dissolved in a type of solvent; thermoplastic resins; and thermocurable resins can be used as the resin coat layer material.

Examples of the ionizing radiation curing resins include photopolymerizable monomers, oligomer, prepolymers, and the like that crosslink/cure when irradiated with UV rays, electron beams, or the like. A single photopolymeric prepolymer may be used or a combination of two or more photopolymeric prepolymers can be used. Cationic polymerization-type and radical polymerization-type photopolymeric prepolymers exist. Examples of cationic polymerization-type photopolymeric prepolymers include epoxy-based resins, vinyl ether-based resins, and the like. Examples of epoxy-based resins include bisphenol-based epoxy resins, novolac-type epoxy resins, cycloaliphatic epoxy resins, aliphatic epoxy resins, and the like. the radical polymerization-type photopolymeric prepolymer is particularly preferably an acrylic prepolymer (hard prepolymer) having not less than two acryloyl groups in the molecule and which forms a three-dimensional network structure when crosslinked/cured because they can be used as material of hardcoat layer.

Examples of the acrylic prepolymer include urethane acrylate, polyester acrylate, epoxy acrylate, melamine acrylate, polyfluoroalkyl acrylate, silicone acrylate, and the like. The urethane acrylate-based prepolymer can be obtained by, for example, obtaining a polyurethane oligomer by reacting polyether polyol or polyester polyol with polyisocyanate, and esterifying the polyurethane oligomer in a reaction with (meth)acrylic acid. The polyester acrylate-based prepolymer can be obtained by, for example, esterifying with (meth)acrylic acid a polyester oligomeric hydroxy group having hydroxy groups at both molecular terminals obtained by the condensation of a polyvalent carboxylic acid and a polyvalent alcohol, or, by esterifying with (meth)acrylic acid an oligomeric distal hydroxy group obtained by adding alkylene oxide to a polyvalent carboxylic acid. The epoxy acrylate-based prepolymer can be obtained by, for example, esterifying by reacting an oxirane ring of a comparatively low molar weight bisphenol-type epoxy resin or novolac epoxy resin with (meth)acrylic acid.

As necessary, the polymer may include other organic or inorganic additives such as, for example, antioxidants, stabilizers, antiozonants, plasticizers, dyes, UV absorbers, hindered amine light stabilizers (HALS), pigments, and the like.

A diluent may be optionally added to these polymer materials described above. Examples of the diluent include propoxylated (2) neopentyl glycol diacrylate (SR9003, manufactured by Sartomer, LLC.), and the like.

Adhesive

In FIGS. 1 and 2, the pressure-sensitive adhesive layer 103 is only formed on one edge of the back surface (second main face) of the substrate 101, but the formation region of the pressure-sensitive adhesive layer 103 is not particularly limited. Depending on the use of the note sheet, the pressure-sensitive adhesive layer 103 may be formed on all regions, 50% or less, 30% or less, or 20% or less of all regions of the back surface of the substrate 101. The pressure-sensitive adhesive layer 103 may be formed on a plurality of regions, and not only in a single region. Additionally, the pressure-sensitive adhesive layer 103 may be formed as randomly or regularly arranged dots in all regions or a portion of the regions.

The pressure-sensitive adhesive layer 103 is a repositionable adhesive layer, that is, the pressure-sensitive adhesive layer 103 enables the note sheet 100 to be reaffixed after being initially fixed to a desired adherend. Examples of the pressure-sensitive adhesive layer 103 described above include a microspherical adhesive layer formed from a polymer of at least one type of alkyl (meth)acrylate monomer having an alkyl group with 4 to 14 carbons and at least one type of polar comonomer.

Examples of the alkyl (meth)acrylate monomer having an alkyl group with 4 to 14 carbons include isooctyl acrylate, 2-octyl acrylate, 4-methyl-2-pentyl acrylate, 2-methylbutyl acrylate, isoamyl acrylate, sec-butylacrylate, n-butylacrylate, 2-ethylhexyl acrylate, isodecyl methacrylate, isononyl acrylate, and isodecyl acrylate.

Examples of the polar comonomer include acrylic acid, N-vinylpyrrolidone, N-vinylcaprolactam, vinyl pyridine, methacrylic acid, acrylamide, fumaric acid, itaconic acid, crotonic acid, acrylonitrile, methacryl nitrile, isobornyl acrylate, hydroxy ethyl acrylate, and hydroxyethylmethacrylate. Note that in addition to the monomers described above, a polyfunctional monomer may be used in combination and a partial cross-linked structure may be formed.

An average particle size of the microspherical adhesive can be, for example, from about 1 μm to about 200 μm. In some embodiments, the average particle size is, for example, from about 60 μm to about 120 μm, or alternatively, from about 30 μm to about 60 μm. By forming the pressure-sensitive adhesive layer 103 using the microspherical adhesive, the adhesive will be able to contact the adherend at points or very small regions. As a result, repositionable characteristics are enhanced. U.S. Pat. No. 3,691,140 (Silver), U.S. Pat. No. 4,166,152 (Baker et al.), and U.S. Pat. No. 5,571,617 (Cooprider et al.) can be referenced for a composition of the adhesive.

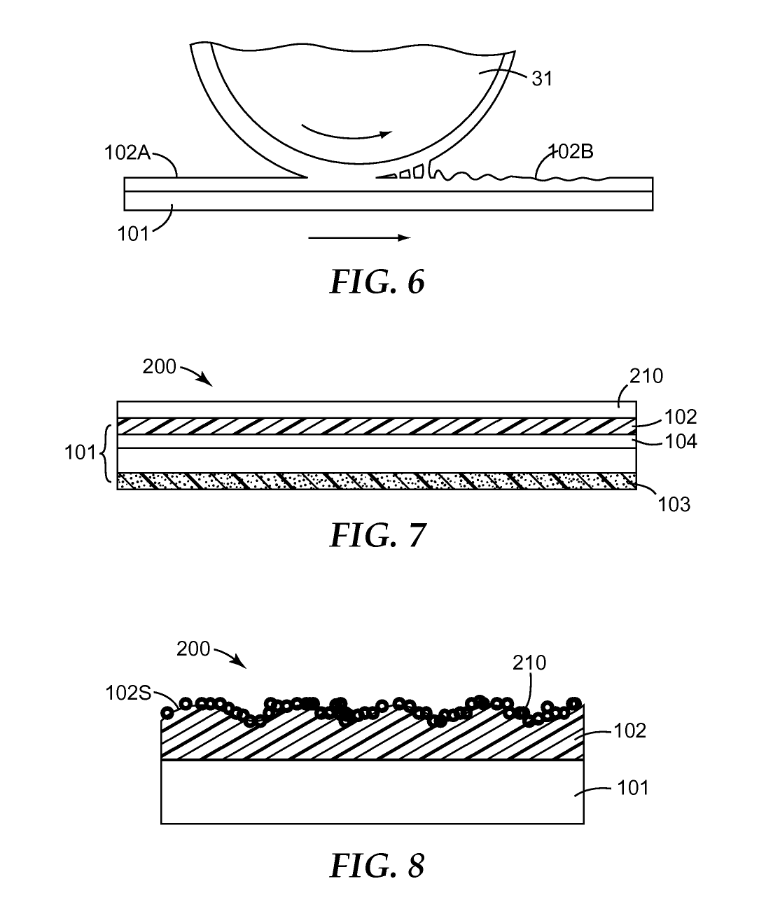

An illustrative method for manufacturing note sheets of the invention will be described while referencing FIGS. 5 and 6. The manufacturing method according to this embodiment includes forming a coat layer precursor by coating a coating material on the substrate and, thereafter, bringing a roller surface into contact with the uncured coat layer precursor.

FIG. 5 illustrates an example of a manufacturing device system used to continuously manufacture the note sheet of this embodiment. This manufacturing device system includes four main stations (first to fourth stations). WO2009/029054 can be referenced for the configuration of this system and a manufacturing method using the same.

The substrate 101 is introduced to the system and first, at a first station 10, the coating material is applied to the first main face in order to form the coat layer precursor. Next, at a second station 20, a treatment such as heating, drying, or the like is performed, as necessary, in order to adjust the viscosity of the coat layer precursor. Then, at a third station 30, fine convexities and concavities are formed in the surface of the coat layer precursor by bringing the roller surface into contact with the coat layer precursor. Thereafter, at a fourth station 40, the coat layer precursor having the fine relief structure formed on the surface thereof is cured to yield the writing receptive layer. The substrate 101 is continuously conveyed between each station by rotating rollers 51 to 54, or the like. Note that for convenience of explanation, the resin substrate 101 coated with the coating material is referred to simply as the “sheet material”, and is referred to as “sheet material 100A to 100D”, based on the change in state of the coat layer precursor as a result of being advanced through each process.

Detailed descriptions of each of the stations are given below.

At the first station 10, the coating material is applied to the substrate 101 using, for example, a die coating device 12 in order to form the coat layer precursor. The coating method is not limited to die coating, and other examples include slide coating, curtain coating, immersion coating, roll coating, gravure coating, knife coating, fluid bearing coating, spray coating, and the like. The viscosity of the coating material (first viscosity) is preferably adjusted to correspond with the coating method so that the coating material can be substantially evenly applied on the substrate 101, and is preferably a material having flowability such as a liquid or a gel. The viscosity of the coating material can be adjusted by adding a solvent, heating or the like. A film thickness of the coat layer precursor can be adjusted by adjusting the viscosity of the coating material, the amount of coating material fed, the solid content of the coating material, the conveying speed of the substrate, or the like. For example, after passing through the second station 20, the thickness of the coat layer precursor is adjusted to be from about 0.5 μm to about 10 μm and preferably from about 0.5 μm to about 5 μm.

At the second station 20, the viscosity of the coat layer precursor that is coated on the substrate 101 is adjusted. That is, the viscosity (second viscosity) is adjusted so as to be suitable for when the coat layer precursor contacts a face-side roller 31 at the third station 30. The second viscosity is greater than the first viscosity. The viscosity may be raised by heating or, alternatively, drying the coat layer precursor in order to vaporize the solvent in the coat layer precursor. Alternatively, when using a coating material including a curing agent, the viscosity can be raised (via the effects of the curing agent) by partially curing the coat layer precursor by heating or by UV ray or electron beam irradiation, or the like. A temperature controllable chamber including a heater or temperature controlled roller or the like is used at the second station 20. Note that when the viscosity does not need to be adjusted, the second station 20 can be omitted.

At the third station 30, a surface of the face-side roller 31 is brought into contact with the coat layer precursor. As illustrated in FIG. 5, the third station 30 may include a backup roller 31B, and a substrate 100B provided with the coat layer precursor that is conveyed from the second station 20 may be sandwiched between the face-side roller 31 and the backup roller 31B. Note that FIG. 5 depicts a case where one face-side roller 31 is used at the third station 30, but a number of face-side rollers is not limited to one and two or more or three or more face-side rollers may be used.

Cylindrical rolls formed from steel, aluminum, chromium plated steel, elastomers, wooden materials, resins, or ceramics, or the rolls covered with an elastomer agent can be used as the face-side roller 31.

Note that the face-side roller 31 itself may be heated or cooled. In this case, the coat layer precursor is also heated or cooled when brought into contact with the face-side roller 31.

After passing through the third station 30, a note sheet 100C in which the fine relief structure is formed on the surface of the coat layer precursor is conveyed to the fourth station 40. The note sheet 100C is exposed to conditions in a chamber of the fourth station 40 in order to solidify or cure the coating material. This step of solidification or curing is typically preferably carried out in a chamber purged by an inert gas such as nitrogen gas or the like. The fourth station 40 includes a source 42 that is a heat source or a source of electromagnetic waves such as ultraviolet (UV) or infrared (IR) radiation, visible light, x-rays, gamma-rays, e-beam or the like. The fourth station 40 may include a plurality of individual stations or a plurality of sources similar or analogous to the source 42. The fourth station 40 may be configured to apply the same type of treatment applied by second station 20 (e.g., heating or cooling). An optional deflector or shield 41 deflects heat or radiation emitted from the source 42 and may direct it toward the coat layer precursor. After passing through the fourth station 40, the fine relief structure is cured while substantially maintaining the form thereof, and becomes a note sheet 100D.

Note that when forming the fine relief structure, the second viscosity of the coat layer precursor is adjusted at the second station 20. While fluidity is not as high as that of the first viscosity had when coating the coating material, excessive solidification does not occur when the coat layer precursor having the second viscosity contacts the face-side roller 31. Therefore, the relief structure of the exposed face of the coat layer precursor formed at the third station 30 can be cured at the fourth station 40 while substantially maintaining the form thereof.

In the embodiment of the present invention, the face-side roller 31 can have a surface that is comparably smooth, with a topography with no noticeable features. However, in some embodiments, the face-side roller 31 may include a design pattern or other identifiable surface feature for imparting a nonrandom pattern and topography onto the surface of the coat layer precursor.

Note that the fine relief structure formed on the surface of the coat layer precursor can be adjusted to have an optimal relief form by adjusting parameters such as the viscosity of the coat layer precursor, the thickness of the coat layer precursor, the rotation speed of the face-side roller 31, the contact angle between the face-side roller 31 and the surface of the resin coat layer, the time to cure, and the like.

FIG. 6 is a drawing schematically illustrating the process at the third station 30 where the fine relief structure is formed in the exposed face of the coat layer precursor using the face-side roller 31. As illustrated in FIG. 6, a coat layer precursor 102A contacts the surface of the rotating face-side roller 31 in accordance with the movement of the substrate 101. Thereafter, in accordance with the movement of the substrate 101 and the rotation of the face-side roller 31, the surface of the face-side roller 31 is separated from the coat layer precursor 102A, but at this time, due to cohesion between the coat layer precursor and the surface of the face-side roller 31, pickup of the coat layer precursor occurs and convexities and concavities are produced on the surface of the coat layer precursor.

While not bound by any particular theory, it is thought that the interaction between the coat layer precursor 102A and the smooth surface of the face-side roller 31 having no prominent features causes the fine relief form on the surface of the coat layer precursor 102A. In this case, a portion of the coat layer precursor 102A has adhesive properties sufficient for adhering to the surface of the face-side roller 31. Additionally, at this point, the coat layer precursor 102A has cohesiveness as a result of the viscosity adjustment performed at the second station 20 and does not flow easily. Thus, when the coat layer precursor 102A contacts the face-side roller 31, an excessive amount of the coat layer precursor 102A will not transfer to the surface of the face-side roller 31, and the coat layer precursor 102A will not deform excessively. However, it is thought that a surface topography is formed that is sufficient to impart the fine convexities and concavities by an outermost layer of the surface of the coat layer precursor 102A by adhering to the face-side roller 31 and, thereafter, separating therefrom.

Note that in some embodiments, in initial processes, a small volume of the coat layer precursor 102A may adhere to the face-side roller 31. However, in subsequent processes, a steady state is achieved in which the coating material continuously separates from the face-side roller 31 at substantially the same rate that the coat layer precursor 102A is picked up by the face-side roller 31.

According to the process of this embodiment, a fine relief form can be provided on the surface of the resin coat layer without recreating the surface features of the face-side roller 31 themselves. This process differs from conventional emboss finishing in that the surface features of the face-side roller 31 are not transferred to the coating layer.

Furthermore, at another station (not illustrated), a primer is applied to at least a portion of the second main face of the resin sheet substrate of the note sheet 100D having the resin coat layer with the fine relief structure, output from the fourth station 40, using a coating apparatus. Thereafter, the primer is dried. Furthermore, after applying a release agent to a portion of the first main face, the pressure-sensitive adhesive is coated and then dried. For example, taking into account the size of the finished product, the pressure-sensitive adhesive is applied to a portion having a width of from about 15 mm to 50 mm along an edge of the back surface of the finished product note sheet. Thereafter, the pressure-sensitive adhesive is dried. Note that the pressure-sensitive adhesive may be applied on an entirety of the back surface of the note sheet, depending on the use thereof. The applied pressure-sensitive adhesive may be cured by a curing device including a source that is a heat source or a source of electromagnetic waves such as ultraviolet (UV) or infrared (IR) radiation, visible light, x-rays, gamma-rays, e-beam or the like, as in the fourth station 40 depicted in FIG. 5.

Furthermore, the continuous note sheet on which the resin coat layer and the pressure-sensitive adhesive layer are formed is conveyed to a cutting station. Alternatively, the coated substrate may be directed to a wind-up station where the continuous note sheet is wound up on a take-up roll, for example. Other process stations (e.g., a packaging station) may be included depending on the use of the finished product.

The embodiment of the present invention has been described above, but the form of the note sheet obtained as a finished product is not limited thereto. Decorations such as characters, colors, borders, and various patterns can be added to a portion of the note sheet after the above processes or during the processes. Additionally, the planar shape of the note sheet may be rectangular, circular, polygonal, indefinite, or a variety of other shapes.

According to this embodiment, a note sheet having both writability and transparency can be provided by forming the fine relief structure on the resin coat layer using a unique method involving a contact process with the roll. However, also in cases when forming note sheets that do not necessarily need transparency, the same process can be used to form the fine relief structure on the front surface and fabricate a note sheet having writability. It is also possible to form a note sheet having a desired color by adding an additive such as a pigment, metal powder, metal oxide, or the like to the resin coating material; and it is possible to use a non-transparent material as the resin substrate.

Next, a note sheet by which writability can be further improved particularly in cases where a writing instrument that uses aqueous ink or aqueous gel-type ink is used will be described as a note sheet of another embodiment.

With the note sheet of the previously described embodiment, high transparency and excellent writability can be ensured in cases where a writing instrument such as a ballpoint pen, pencil, or the like is used due to the fine relief structure formed on the resin coat layer. However, in cases where the surface of the resin coat layer is formed from a hardcoat material such as acrylic resin or the like, there are cases where excellent writability using other writing instruments cannot be obtained. Reasons for this are because aqueous ink and aqueous gel-type ink is repelled due to the surface not being an aqueous ink absorbing layer material and due to the effects of surface tension wettability with respect to aqueous ink being low.

FIGS. 7 and 8 illustrate cross-sectional views of the note sheet of the other embodiment. As illustrated in FIG. 7, with this note sheet, inorganic nanoparticles are dispersed/disposed on the fine relief structure 102S of the resin coat layer 102 of the note sheet of the embodiment described above. Here, a layer where the inorganic nanoparticles are disposed is referred to as inorganic nanoparticle layer 210. Note that as illustrated in FIG. 8, because a size of the inorganic nanoparticles is sufficiently small compared to the arithmetic surface roughness (Rₐ) or the distance between adjacent peaks (NNp) of the fine relief structure formed using the face-side roller and, furthermore, because the size is sufficiently smaller than the wavelength of the visible range, there is nearly no effect on the transparency of the note sheet. Additionally, the inorganic nanoparticle layer 210 is thin enough so as not to affect the relief structure of the resin coat layer 102. Thus, writability with respect to writing instruments using aqueous ink or aqueous gel-type ink can be improved while maintaining transparency.

Specifically, inorganic nanoparticles having an average particle diameter that is shorter than the wavelength in the visible region, for example, particles having an average particle diameter that is not less than 1 nm and not more than 100 nm, not more than 50 nm, or more preferably, not more than 10 nm can be used for the inorganic nanoparticle layer 210. The particle diameter can be measured by a known method such as a transmittance electron microscopy (TEM), a dynamic light scattering, or a laser analysis scattering method. Additionally, the inorganic nanoparticles can include silica, alumina, tin oxide, antimony oxide, zirconia, titania, or a metal oxide selected from a combination of two or three or more types of these. Typically, silica particles can be used.

In order to form the inorganic nanoparticle layer 210 on the fine relief structure 102S of the resin coat layer 102, after forming the coat layer 102, a solution including the inorganic nanoparticles is applied on the resin coat layer and, thereafter, dried. For example, when using silica particles, water is used as a vehicle and a colloidal solution in which silica nanoparticles are dispersed in water (SNOWTEX®, manufactured by and available from Nissan Chemical Industries, Ltd.) is applied.

In order to sufficiently obtain the surface modification effects of the resin coat layer 201 by the inorganic nanoparticles, the coating solution including the inorganic nanoparticles is a colloidal solution in which a solid content of the nanoparticles included is at least about 1% or more, preferably about 5% or more or about 10% or more.

Furthermore, it is sufficient that the average particle diameter of the inorganic nanoparticles be not less than about 1 nm, preferably not less than about 3 nm, and more preferably not less than about 10 nm. However, if the size of the inorganic nanoparticles exceeds about 100 nm, the writability improving effects with respect to aqueous gel ink pens tends to decline. From this perspective, the size is not more than about 60 nm and preferably not more than about 30 nm. The average particle diameter described above are sufficiently smaller compared to the wavelength of visible light and, thus, there is almost no effect on the haze value of the resin coat layer 102.

By further including a binder in the solution including the inorganic nanoparticles, the inorganic nanoparticles can be firmly bonded to the surface of the resin coat layer 102. Note that materials that function as an aqueous ink absorbing layer may be added to the colloidal solution. For example, if a binder such as polyvinylalcohol (PVA) or the like is added, drying time of written ink can be shortened and aqueous ink absorbing capacity can be added to the inorganic nanoparticle layer 210.

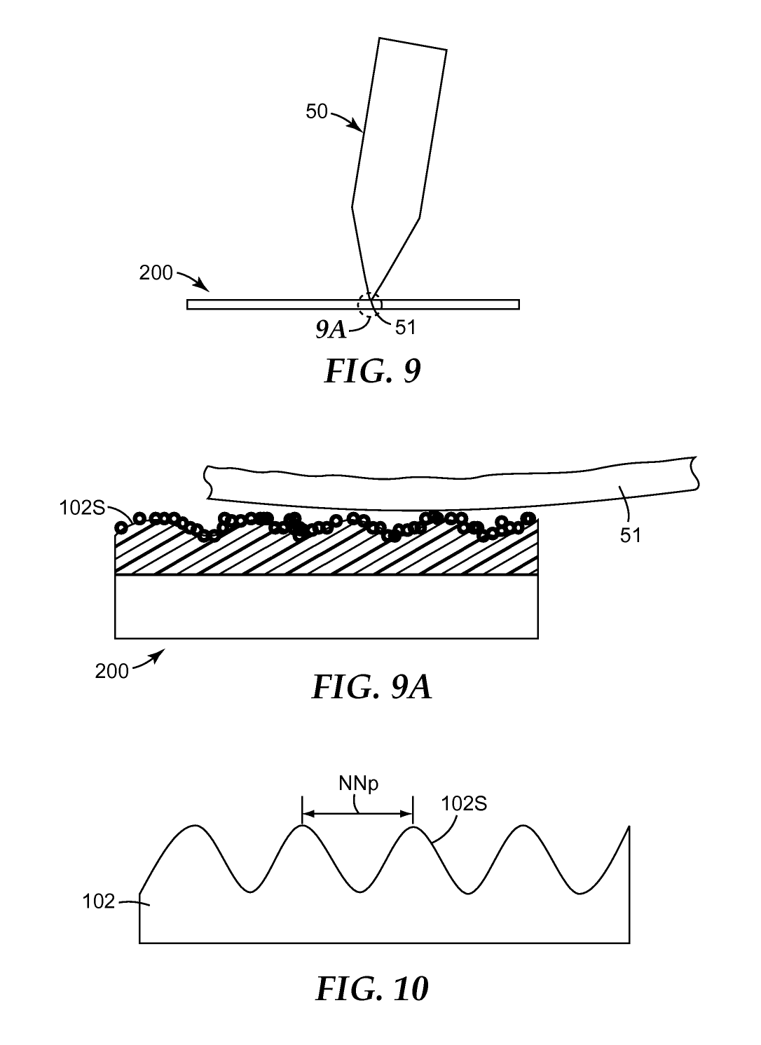

FIG. 9 is a schematic partial cross-sectional view illustrating a contact state between a pen tip 51 of a writing instrument 50 and a front surface of the note sheet 200 in a case where the writing instrument 50 using an aqueous gel-type ink is used to write on the front surface of the note sheet 200. FIG. 9A is an enlarged cross-sectional view of the contact state between pen tip 51 and the surface of the note sheet 200. As illustrated in FIG. 9A, when writing on the front surface of the note sheet using an aqueous ballpoint pen or a pen using aqueous gel-type ink, the presence of the nano-level fine particles of the front surface, provided by the inorganic nanoparticle layer 210 on the fine relief structure 102S, reduces the repulsion of the aqueous ink or aqueous gel-type ink and improves the fixation of the ink on the front surface of the note sheet 200. As a result, it is possible to improve writability when using these writing instruments.

### EXAMPLES

The invention will be further explained with reference to the following illustrative Examples of the present invention and Comparative Examples.

### Examples 1 to 24

In Examples 1 to 24, notes of the invention were made using, as the substrate, primer treated polyethylene terephthalate (PET) film (MELINEX™ 618, commercially available from DuPont Teijin Films U.S.) having a width of about 9 inches (22.86 cm) and a thickness of about 5 thousandths of an inch (0.127 mm), was used as the resin substrate.

The coat layer precursor was, as indicated in Table 1, made with commercially available ultraviolet-curable acrylic resin hardcoat material (906 Hardcoat, manufactured by 3M) used alone, or a mixed in a blend with a propoxylated (2) neopentyl glycol diacrylate (SR9003, manufactured by Sartomer, LLC.).

Using a continuous manufacturing system having the same configuration as the manufacturing system illustrated in FIG. 5, the resin coating material was applied on the PET film and, thereafter, a face-side roller was used to form a fine relief structure on the surface of the resin coat layer. Then, using a coating device and heating device of another system, a primer was applied to a back surface side of the PET substrate having the fine relief structure, a release agent was applied to the front surface side, and an adhesive was applied to a portion of the back surface of the PET substrate. The PET substrate was dried successively in an oven after the application of each of the coating agents. Thus, a rolled-up note sheet laminate having a pressure-sensitive adhesive was obtained. Then, the note sheets of the Examples were obtained by cutting this laminate to a desired size.

Specifically, at the first station 10, a die coating device (HIRANO® Multi Coater MODEL M-200 Coater, from Hirano Tecseed Company, Ltd. in Nara Prefecture, Japan) was used as the coating device of the coating material. A gap between the die slot of the coater and the sheet substrate was set to be about 7 mm, and the sheet substrate was conveyed at a speed of about 50 feet/minute (about 15.3 meters/minute). Then, in a heating furnace at the second station 20, the solvent in the coat layer precursor applied to the sheet substrate was dried. Thicknesses of the coat layer precursors after passing through the second station 20 in each of the Examples are shown in Table 1.

At the third station 30, a surface of a singular face-side roller having a roller surface with a width of about 9 inches (228.6 mm) was brought into contact with the coat layer precursor so as to press on the coat layer precursor with a gauge pressure of about 30 psig. The surface of the face-side roller used was substantially flat and ethylene propylene diene monomer (EPDM) rubber having an arithmetic average surface roughness (Rₐ) of about 32 and a shore A hardness of about 60 was used as a material thereof.

### Comparative Examples 1 to 3

Comparative Examples 1 to 3 are flags using commercially available resin film substrates. The product names and manufacturing companies of the flags of each of the Comparative Examples are listed below.

### Comparative Example 1

### Commercially available flag (Product name: “Tomeimidashi”, available from Sumitomo 3M Co., Ltd.)

### Comparative Example 2

### Commercially available flag (Product name: “Hattamamayomeru” available from Ryohin Keikaku Co., Ltd.)

### Comparative Example 3

### Commercially available flag (Product name: “Memo Pad Notes (flag)”, available from Sekisui Chemical Co., Ltd.)

### Evaluation of Properties

Transmittance and Haze:

Transmittance and haze value were measured using a haze meter (Haze-Gard Plus™ HB4725 available from BYK-Gardner of Columbia, Md.), in accordance with ASTM D1003. The haze values were measured at three different locations using the formula below for the note sheet of each Example, and these values were averaged:

Haze value=(scattered light ray transmitted light volume/total light ray transmitted light volume)×100%.

Relief:

Relief form of the resin note sheet (measurements of the arithmetic surface roughness Ra and the distance between adjacent peaks NNp)

The arithmetic surface roughness Rₐ and the distance between adjacent peaks NNp were measured using Laser Microscope VK-9710 (manufactured by Keyence, Japan). Substantially square of less than 1 cm regions, in substantially the center of the note sheet of each Example were selected as measurement subjects. As illustrated in FIG. 10, the distance between adjacent peaks NNp was the distance between two adjacent convexities, and was calculated as an average value throughout the measurement subject regions. The distance between adjacent peaks NNp was calculated by the following equation, wherein a peak density was measured as a number of peaks in a unit area (1 μm²).

$$NNp = \frac{1}{\sqrt{peak density}}$$

Writability:

Two types of ballpoint pens/writing instruments (an oil-based ballpoint pen SG-100-07: tip size=0.7 mm, ink=SA-7N, manufactured by Mitsubishi Pencil Co., Ltd.; and a pencil Mitsu-Bishi 9800, hardness=HB) were used to consecutively draw five circles having diameters of about 2 inches on the front surface of the note sheet. Writability was scored using a three-step scale, taking the following into account: 1) Presence/absence of fading of the drawn line; 2) Darkness of the drawn marks; 3) Ease of writing; 4) Fixation of the drawn marks (presence/absence of bleeding when rubbing the drawn marks), and the like. Writability was scored on the following scale: 3=Very good, 2=Good, 1=Acceptable. In cases where writability was substantially equivalent to that when writing on regular paper, writability was given a score of 3 (Very Good).

### Results

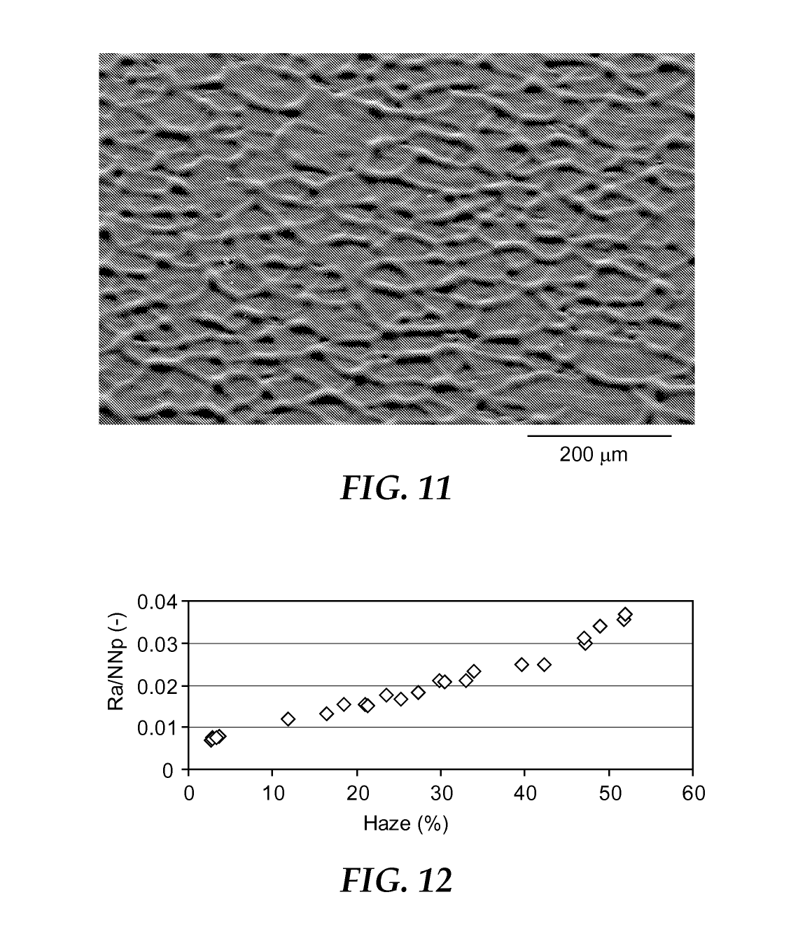

A photomicrograph of the fine relief structure of the front surface of the note sheet of Example 4 is shown in FIG. 11.

The manufacturing conditions (composition ratio of the coating material, film thickness of the coat layer precursor), relief form evaluations (surface roughness and distance between adjacent peaks), optical properties (transmittance and haze), and writability for each of Examples 1 to 24 are shown in Table 1.

The optical properties of the note sheet of Example 1 and of the commercially available film type flags used for the Comparative Examples are shown in Table 2.

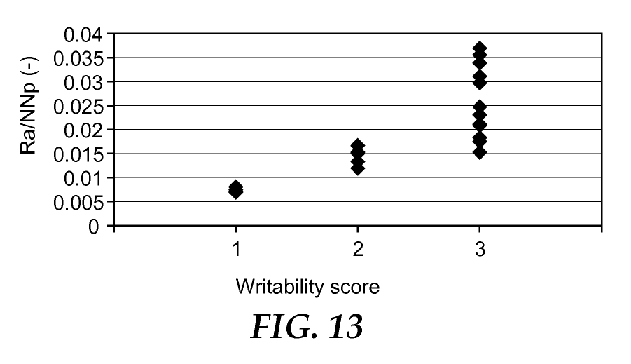

Haze values and (Rₐ/NNp) values based on the data of Table 1 are shown in FIG. 12. Additionally, writability and (Rₐ/NNp) values are shown in FIG. 13.

TABLE 1

| | Coating Material | Thickness | | | | | | | |
|---|---|---|---|---|---|---|---|---|---|
| Example | (906HC:9003) | Target | Rₐ | NN | Ra/NN | Transmittance | Haze | Ballpoint pen | HB pencil |
| No. | mixing ratio | (μm) | (μm) | (μm) | (—) | (%) | (%) | writability*1 | writability*2 |
| 1 | 100:0 | 1.33 | 0.52 | 24.8 | 0.0210 | 94 | 29.9 | 3 | 3 |
| 2 | 100:0 | 1.5 | 0.51 | 21.9 | 0.0232 | 94.2 | 33.9 | 3 | 3 |
| 3 | 100:0 | 1.75 | 0.66 | 26.8 | 0.0247 | 93.7 | 39.6 | 3 | 3 |
| 4 | 100:0 | 2 | 0.68 | 27.2 | 0.0248 | 94.2 | 42.3 | 3 | 3 |
| 5 | 100:0 | 2.5 | 0.94 | 31.7 | 0.0298 | 94 | 47.2 | 3 | 3 |
| 6 | 100:0 | 3 | 1.16 | 37.3 | 0.0312 | 94 | 47 | 3 | 3 |
| 7 | 100:0 | 3.5 | 1.44 | 42.3 | 0.0340 | 94.1 | 49 | 3 | 3 |
| 8 | 100:0 | 4 | 1.93 | 54.3 | 0.0356 | 94.1 | 51.8 | 3 | 3 |
| 9 | 100:0 | 5 | 2.14 | 58.2 | 0.0369 | 93.8 | 52 | 3 | 3 |
| 10 | 90.5:9.5 | 2 | 0.75 | 48.9 | 0.0153 | 94.6 | 21 | 3 | 3 |
| 11 | 90.5:9.5 | 2.5 | 0.99 | 56.8 | 0.0175 | 94.6 | 23.5 | 3 | 3 |
| 12 | 90.5:9.5 | 3 | 1.20 | 65.3 | 0.0183 | 93.7 | 27.3 | 3 | 3 |
| 13 | 90.5:9.5 | 3.5 | 1.47 | 70.5 | 0.0209 | 94.5 | 30.4 | 3 | 3 |
| 14 | 90.5:9.5 | 4 | 1.65 | 78.5 | 0.0210 | 94.7 | 33 | 3 | 3 |
| 15 | 100:0 | 0.93 | 0.30 | 18.0 | 0.0166 | 94.2 | 25.3 | 3 | 2 |
| 16 | 100:0 | 0.75 | 0.22 | 14.5 | 0.0151 | 93.8 | 21.3 | 3 | 2 |
| 17 | 90.5:9.5 | 1.08 | 0.38 | 32.0 | 0.0120 | 94.7 | 11.9 | 2 | 2 |
| 18 | 90.5:9.5 | 1.5 | 0.50 | 37.2 | 0.0134 | 94.5 | 16.4 | 2 | 2 |
| 19 | 90.5:9.5 | 1.75 | 0.70 | 45.3 | 0.0154 | 94.5 | 18.5 | 2 | 2 |
| 20 | 80:20 | 1 | 0.26 | 37.7 | 0.0070 | 92.9 | 2.73 | 3 | 1 |
| 21 | 80:20 | 0.9 | 0.25 | 32.2 | 0.0076 | 93 | 2.89 | 3 | 1 |
| 22 | 80:20 | 0.8 | 0.22 | 29.8 | 0.0073 | 93 | 2.87 | 3 | 1 |
| 23 | 80:20 | 0.7 | 0.20 | 24.6 | 0.0079 | 93 | 3.67 | 3 | 1 |
| 24 | 80:20 | 0.6 | 0.14 | 18.8 | 0.0075 | 92.8 | 3.37 | 3 | 1 |

TABLE 2

| Sample | Haze (%) | Transmittance (%) |
|---|---|---|
| Example 1 | 29.9 | 94.0 |
| Comparative Example 1 | 85.16 | 79.18 |
| Comparative Example 2 | 77.67 | 97.01 |
| Comparative Example 3 | 66.80 | 96.40 |

### Examples 25 to 41

In Example 25, primer treated PET film (MELINEX™ 618, commercially available from DuPont Teijin Films U.S.) having a width of about 9 inches (22.86 cm) and a thickness of about 2 thousandths of an inch (0.0508 mm), was used as the substrate. Additionally, a commercially available ultraviolet-curable acrylic resin hardcoat material (906 HC, manufactured by 3M) was used alone as the coating material. Other than these modification, the note sheet of Example 25 was fabricated according to the same process conditions as those described for Examples 1 to 24.

In Examples 26 to 41, a mixed solution fabricated by mixing colloidal silica and another material (at a predetermined composition ratio) was applied on the exposed face having the fine relief structure of the note sheet of Example 25. Thereafter, a layer of inorganic nanoparticles was formed on the surface having the relief structure by drying the note sheet at a temperature of about 100° C. Note that in Example 26, a mixed solution free of colloidal silica was used and, therefore, the layer of inorganic nanoparticles was not formed.

The mixed solution described above was fabricated by mixing any of the following five types of colloidal silica aqueous solution (SNOWTEX®, manufactured by Nissan Chemical Industries, Ltd.; available as ST-C, ST-CXS, ST-CM, ST-XL, and MP-ZL), water, a thickening agent (PRIMAL™ TT-935, manufactured by ROHM AND HAAS JAPAN), and aqueous ammonia, which is a neutralizer (manufactured by WAKO PURE CHEMICAL INDUSTRIES, LTD.) at a predetermined composition ratio. Composition conditions of the solutions for each Example are shown in Table 4.

The transmittance and haze value of Examples 25 and 31 were measured according to the same conditions as those of Examples 1 to 24 in order to confirm the effect of the presence/absence of the inorganic nanoparticles on the optical properties. The results are shown in Table 3. Additionally, Comparative Example 5 was fabricated by coating the mixing solution including colloidal silica aqueous used in Example 31 directly on a surface of the PET film which is the same one used in Example 25 without fabricating the fine relief structure, and then drying the note sheet.

Writability of Examples 25 and 31 and Comparative Example 5 is shown in Table 3.

Writability of Examples 25 to 41 was evaluated for three types of gel-type ink ballpoint pens (1 to 3 below) and a pencil (4 below). Writability was scored using a three-step scale, taking the following into account: 1) Presence/absence of fading of the drawn line and 2) Darkness of the drawn marks. Writability was scored on the following scale: 3=Very good, 2=Good, 1=Acceptable. In cases where writability was substantially equivalent to that when writing on regular paper, writability was given a score of 3 (Very Good). The results are shown in Tables 3 and 4.

1) uni-ball Siguno (black), manufactured by Mitsubishi Pencil Co., Ltd.

2) Gel Ballpoint Pen Sarasa (black), manufactured by Zebra Co., Ltd.

3) G-2 (black), manufactured by Pilot Corporation

4) HB Pencil 9800, manufactured by Mitsubishi Pencil Co., Ltd.

TABLE 3

| | | Coat layer | | | | | | Writability | | | |
|---|---|---|---|---|---|---|---|---|---|---|---|
| | | precursor | | | | | | Gel ink | Gel ink | Gel ink | HB |
| Example | Nanoparticle | thickness | Rₐ | Transmittance | Haze | NNp | Ra/NNp | ballpoint | ballpoint | ballpoint | Pencil |
| No. | layer | (μm) | (μm) | (%) | (—) | (μm) | (—) | pen 1 | pen 2 | pen 3 | 4 |
| 25 | NA | 1.5 | 0.708 | 89.9 | 47.0 | 24.8 | 0.0239 | 1 | 1 | 1 | 3 |
| 31 | Present | 1.5 | — | 89.9 | 41.6 | — | — | 3 | 3 | 2 | 3 |
| Comparative | Present | NA | NA | NA | NA | NA | NA | 1 | 1 | 1 | 3 |
| Example 4 | | | | | | | | | | | |

TABLE 4

| | | | Solids/Silica | | | | Writability | | | |
|---|---|---|---|---|---|---|---|---|---|---|
| | Silica | Silica | aqueous | | | | Gel ink | Gel ink | Gel ink | HB |
| Example | aqueous | particle size | solution | Water | Thickener | Neutralizer | ballpoint | ballpoint | ballpoint | Pencil |
| No. | solution | (nm) | (%) | (%) | (%) | (%) | pen 1 | pen 2 | pen 3 | 4 |
| 26 | ST-C | 10-20 | 0 | 99 | 1 | 0.1 | 1 | 1 | 1 | 3 |
| 27 | ST-C | 10-20 | 0.1 | 99.9 | 1 | 0.1 | 1 | 1 | 1 | 3 |
| 28 | ST-C | 10-20 | 0.5 | 98.5 | 1 | 0.1 | 2 | 1 | 1 | 3 |
| 29 | ST-C | 10-20 | 1 | 99 | 1 | 0.1 | 2 | 2 | 2 | 3 |
| 30 | ST-C | 10-20 | 2 | 97 | 1 | 0.1 | 2 | 2 | 2 | 3 |
| 31 | ST-C | 10-20 | 5 | 94 | 1 | 0.1 | 3 | 3 | 2 | 3 |
| 32 | ST-C | 10-20 | 10 | 89 | 1 | 0.1 | 3 | 3 | 3 | 3 |
| 33 | ST-C | 10-20 | 18 | 81 | 1 | 0.1 | 3 | 3 | 3 | 3 |
| 34 | ST-CXS | 4-6 | 5 | 93.9 | 1 | 0.1 | 3 | 3 | 3 | 3 |
| 35 | ST-CXS | 4-6 | 2 | 96.9 | 1 | 0.1 | 3 | 3 | 3 | 3 |
| 36 | ST-CM | 20-30 | 5 | 93.9 | 1 | 0.1 | 3 | 3 | 2 | 3 |
| 37 | ST-CM | 20-30 | 2 | 96.9 | 1 | 0.1 | 2 | 2 | 1 | 3 |
| 38 | ST-XL | 40-60 | 5 | 93.9 | 1 | 0.1 | 3 | 3 | 2 | 3 |
| 39 | ST-XL | 40-60 | 2 | 96.9 | 1 | 0.1 | 3 | 2 | 1 | 3 |
| 40 | MP-ZL | 70-100 | 5 | 93.9 | 1 | 0.1 | 3 | 3 | 1 | 3 |
| 41 | MP-ZL | 70-100 | 2 | 96.9 | 1 | 0.1 | 3 | 3 | 1 | 3 |

The complete disclosure of all patents, patent documents, and publications cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

1. A note sheet comprising: (1) a substrate having a first main face and a second main face; (2) a writing receptive layer on the first main face of the substrate, the writing receptive layer having an exposed face having a fine relief structure wherein an arithmetic average surface roughness (Rₐ) of the fine relief structure is not less than about 0.1 μm, and a ratio (Rₐ/NNp) of the arithmetic average surface roughness (Rₐ) to a distance between adjacent peaks (NNp) is not less than about 0.01; and (3) at least one segment of repositionable pressure-sensitive adhesive layer on at least a portion of the second main face; wherein the substrate and writing receptive layer having a visible transmittance of at least about 80% and a haze of not more than about 60%.

2. The note sheet of claim 1 wherein the writing receptive layer covers substantially all of the first main face of the substrate.

3. (canceled)

4. The note sheet of claim 1 wherein the ratio (Rₐ/NNp) of the arithmetic average surface roughness (Rₐ) to the distance between adjacent peaks (NNp) of the fine relief structure is not more than about 0.04.

5. The note sheet of claim 1 wherein the writing receptive layer comprises an ionizing radiation cured resin.

6. The note sheet of claim 1 wherein the writing receptive layer has a hardness greater or equal to pencil hardness H.

7. The note sheet of claim 1 further comprising particles disposed on the writing receptive layer, the particles having an average diameter of not more than about 100 nm.

8. The sheet of claim 7 wherein the particles are silica particles.

9. The sheet of claim 1 wherein the repositionable pressure-sensitive adhesive layer substantially all of the second main face of the substrate.

10. A method for making a note a sheet comprising:
(1) providing a substrate having a first main face and a second main face;
(2) applying a transparent resin coating material to the first main face so as to form a coat layer precursor having a first main face;
(3) contacting the surface of the coat layer precursor with a roller surface and then separating the roller surface from the coat layer precursor;
(4) curing the coat layer precursor to form a resin coat layer; and
(5) applying at least one segment of repositionable pressure-sensitive adhesive on at least a portion of the second main face of the substrate;
thereby yielding a transparent note sheet.

11. The method of claim 9 further comprising, after forming the resin coat layer: coating a solution comprising nanoparticles having an average diameter of about 100 nm on less, on the resin coat layer.
